(19) United States
(12) Patent Application Publication
(10) Pub. No.: US 2009/0036119 A1
(43) Pub. Date: Feb. 5, 2009

(54) Method and System for a Wireless Headset Receptacle

(76) Inventors: Alton Smith, Woodstock, GA (US); Gregory Carras, Woodstock, GA (US)

Correspondence Address: Fay Kaplun & Marcin, LLP/ Motorola, 150 Broadway Suite 702, New York, NY, 10038, US

(21) Appl. No.: 11/830,241

(22) Filed: Jul. 30, 2007

(51) Int. Cl. H04Q 7/20

(52) U.S. Cl. 455/432.1

(57) ABSTRACT

Described are a method and a system for a wireless headset receptacle. The method includes a step of detecting one of a presence and an absence of a wireless receiver from a receptacle within a communication device. The wireless receiver includes a power supply and an interface for wireless communication with the communication device. The method also includes a step of performing at least one action based on one of the detected presence and the detected absence of the wireless receiver from the receptacle.

### FIELD OF INVENTION

The present invention generally relates to providing a convenient receptacle for storing a wireless headset of a mobile computer, wherein the receptacle provides extended functionality and simplified interactions between the headset and the mobile computer.

### BACKGROUND

Business enterprises as well as individuals rely on mobile computers (“MCs”), in a variety of situations ranging from basic everyday tasks, such as telecommunications, to highly specialized procedures, such as inventory gathering. As the benefits of utilizing MCs continue to be realized across increasingly diverse industries, the features and capabilities of these products are expanding at a correspondingly rapid pace. In many industries, MCs have gone from fashionable accessories to essential business components used by all levels of personnel.

A personal area network (“PAN”) may be defined as a computer network used for communication among computer devices, including MCs such as mobile telephones and personal digital assistants, which are within a close proximity to one person. A PAN may be used for communication among the personal devices themselves (e.g., an intrapersonal communication), or for connecting to a higher-level network such as the Internet (e.g., an uplink). Furthermore, a PAN may allow for wireless communications between the devices via a wireless personal area network (“WPAN”). Exemplary WPANs utilize networking technologies such as Bluetooth communications, infrared data association (“IrDA”), and ultra-wide band (“UWB”) radio communications.

Bluetooth technology is a radio standard and communications protocol primarily designed for low power consumption, having a short range based on inexpensive transceiver microchips in each compatible device. Accordingly, Bluetooth technology allows these compatible devices to communicate with each other while they are within an operable range. Bluetooth devices use a radio communications system, and thus, do not need to communicate via a line-of-sight communication link. As long as the received transmission is powerful enough, Bluetooth devices may communicate with each other regardless of any objects (e.g., walls) located between the devices.

### SUMMARY OF THE INVENTION

The present invention relates to a method and a system for a wireless headset receptacle. The method includes a step of detecting one of a presence and an absence of a wireless receiver from a receptacle within a communication device. The wireless receiver includes a power supply and an interface for wireless communication with the communication device. The method also includes a step of performing at least one action based on one of the detected presence and the detected absence of the wireless receiver from the receptacle.

### BRIEF DESCRIPTION OF THE DRAWINGS

FIG. 1 shows an exemplary mobile computer (“MC”) according to the exemplary embodiments of the present invention.

FIG. 2 shows an exemplary method according to the exemplary embodiments of the present invention.

FIG. 3 shows a table listing exemplary actions performed by the central processing unit (“CPU”) based on the detected presence or the detected absence of the headset within the receptacle according to the exemplary embodiments of the present invention.

### DETAILED DESCRIPTION

The present invention may be further understood with reference to the following description of exemplary embodiments and the related appended drawings, wherein like elements are provided with the same reference numerals. The present invention is related to providing a convenient receptacle for storing a wireless receiver, such as a wireless headset, within a communication device, such as a mobile computer (“MC”), wherein the receptacle provides extended functionality and simplified interactions between the headset and the mobile computer. Specifically, the present invention is related to systems and methods for performing functions such as storing the headset, providing a battery charge to the headset, pairing the headset with the MC, etc. Furthermore, both the headset and the MC may be configured via complimentary operations that allows for the activating one or more applications on the headset and/or the MC. Thus, the present invention allows for improved utility of the headset and the MC through direct communication between the two components via the receptacle according to the exemplary embodiments of the present invention. It should be noted that while the term headset is used throughout the description in reference to the wireless receiver, any type of wireless receiver (e.g., “hands-free” head-piece, earpiece, etc.) is within the scope of the present invention.

Those skilled in the art would understand that the term “MC” according to the present invention may also be used to describe any mobile computing device, such as, for example, cellular telephones, voice over Internet protocol (“VoIP”) telephone receivers, personal digital assistants (“PDAs”), laptop computers, portable barcode scanners (i.e., laser and/or imager-based scanners), radio frequency identification (“RFID”) readers, global positioning system (“GPS”) devices, digital cameras, portable media players, medical equipment, etc. Furthermore, it should be noted that while the communication device described in this disclosure relate to MCs, additional embodiments within the scope of the present invention are not limited to mobile devices. For example, the communication device may include a stationary desktop computer, a wireless communication interface within an automobile dashboard, a gaming console, etc. Accordingly, a user may remove the exemplary headset from a receptacle of the dashboard in order to initial a call. Likewise, the user replacing the headset onto the dashboard may terminate the call. Alternatively, the replacing of the headset onto the dashboard may trigger a different application or function, such as the activation of a dashboard speakerphone mode during a call. In addition, those skilled in the art would further understand that various functionalities may be added to the MC through software modules.

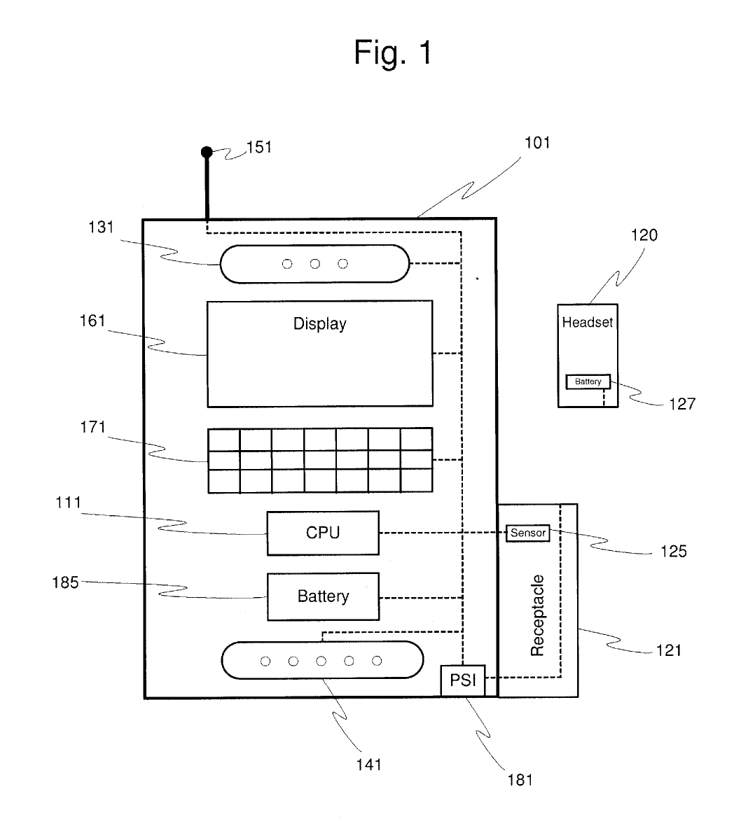

FIG. 1 shows an MC 101 according to the exemplary embodiments of the present invention. The MC 101 may be a multi-purpose mobile telephone capable of communication with a Bluetooth compatible device, such as, a headset 120. The MC 101 may include a processor (e.g., CPU 111), a speaker 131, a microphone 141, an antenna 151, a display 161, and a keypad 171. In addition, the MC 101 may include a power supply input 181 (e.g., an AC power adaptor) for receiving power in order to charge a battery 185 of the MC 101, as well as to charge a separate battery 127 of the headset 120. Furthermore, the MC 101 may also include a headset receptacle 121 for receiving the headset 120. The receptacle 121 may be located on the MC 101 for convenient access by a user and may be adapted to the shape of the headset 120. In addition, the receptacle 121 may include a connection (e.g., a port, a socket, a dock, etc.) that allows for the headset 120 to maintain an electronic communication with the MC 101. For example, the connection within the receptacle 121 may transmit/receive data between the headset 120 and the MC 101. Furthermore, the connection may transmit a power charge from the MC 101 to a battery within the headset 120. In addition, the CPU 111 may execute instructions and manage one or more applications of the MC 101 based on, among other factors, the presence and/or removable of the headset 120 in the receptacle 121.

According to the exemplary embodiments of the present invention, the receptacle 121 may include at least one sensor 125 integrated into the MC 101. The sensor 125 may be coupled to an electronic architecture of the MC 101 that dispatches data to the CPU 111. For instance, the exemplary sensor 125 may include a depressible and/or retractable switch within the receptacle 121, wherein the switch is selectively protruding or depressed based on the absence or presence of the headset 120 in the receptacle 121, respectively. According to this embodiment, the switch may be designed to engage with the headset 120 (or at least a portion of the headset 120) while the headset 120 is within the receptacle 121. Specifically, the switch of the exemplary sensor 125 may protrude from within the receptacle 121 while the headset 120 detached from the MC 101. Likewise, when the headset 120 is placed within the receptacle 121, this switch may then be depressed (or otherwise retracted) into the receptacle 121. Thus, the exemplary sensor 125 may sense the protrusion and the depression of the switch in order to determine the absence and presence of the headset 120 within the receptacle 121.

According to additional embodiments of the present invention, both the receptacle 121 and the headset 120 (or at least a portion of the headset 120) may include electrical conductive materials. The sensor 125 may be capable of determining the presence or absence of the headset 120 by comparing a first conductivity value measured at the sensor 125 when the headset 120 is present in the receptacle 121 to a second conductivity value measure at the sensor 125 when the headset is absent from the receptacle 121. Other alternative embodiments of the sensor 125 may utilize a variety of sensing methods to determine the presence and absence of the headset 120 within the receptacle 121. These methods may include, but are not limited to, comparisons of values obtained from magnetic detections, optical detections, mass detections, electrical capacitance, etc. Furthermore, it is noted that the sensors 125 may be of any size. However, according to the preferred embodiments of the present invention, the sensor 125 may be small so that it does not add any weight to or take up too much space on the MC 101. Because the MC 101 may operate on a battery, the sensor 125 may preferably have low power consumption.

As will described in greater detail below, the detections made by the sensor 125 may selectively activate and/or deactivate specific applications and functions of the MC 101. When the sensor 125 detects that the headset 120 is within the receptacle 121, the sensor 125 may transmit a signal to the CPU 111 indicating the presence of the headset 120. The CPU 111 may then perform appropriate actions, such as, deactivating the headset 120, deactivating the display 161, activating a stand-by mode for the MC 101, transmitting a power charge to the headset 120, etc. Conversely, when the sensor 125 detects that the headset 120 is not within the receptacle 121, the sensor 125 may transmit a different signal to the CPU 111 indicating the absence of the headset 120. The CPU 111 may then perform alternative appropriate actions, such as, activating the headset 120, activating the display 161, deactivating a stand-by mode for the MC 101, ceasing the transmission of a power charge to the headset 120, etc.

Those of skill in the art would understand that the MC 101 may include further application-specific components (not shown). These components may include, but are not limited to, a keypad light source, a touch screen, a digital camera, a digital audio recorder, an optical scanner, a scanner trigger, an RFID tag, an RFID reader, a wireless network interface controller (i.e., a 802.11x network card), etc. According to the exemplary embodiments of the present invention, the CPU 111 of the MC 101 may monitor any input received via one or more application-specific component during user activity. This received input may be used by the CPU 111 to determine the functionality and/or a mode of operation for the MC 101 and/or for one or more of the components of the MC 101.

According to exemplary embodiments of the present invention, the various operating modes and functions of the MC 101 may include, but are not limited to, the power state of the display 161 (e.g., full power, stand-by mode or low power, no power, etc.), the brightness of the display 161, the power state of the touch screen and/or keypad light source, the power state of telecommunication interfaces (e.g., the speaker 131, a microphone 141, etc.), the power state and/or operating mode of various computing and communication assets, any combination of the above-mentioned functions, etc. Thus, the placement of the headset 120 into the receptacle 121 may relate to an inactive or idle usage period for the MC 101, whereby each of the components of the MC 101 may be turned off.

As described above, the MC 101 may charge the headset 120 while the headset 120 is located within receptacle 121. Furthermore, the MC 101 may supply the charge to the headset 120 either while the MC 101 is a retained in a cradle (e.g., connected to an external power source) or while the MC 101 is detached from the cradle (e.g., disconnected from an external power source). According to an exemplary embodiment, while the MC 101 is detached from an external power source, an electric charge, such as a “trickle” charge, may be supplied from the MC 101 to a storage battery within the headset 120 at a continuous low rate in order to keep the battery fully charged. Alternatively, while the MC 101 is connected to an external power source, the headset 120 may receive a higher charging current via an electrical connection within the receptacle 121. Therefore, the exemplary MC 101 of the present invention may eliminate the need for a separate power supply input on the headset 120, thereby lowering the manufacturing costs associated with the MC 101 and/or the headset 120. In addition, utilizing a single external power source for charging both the MC 101 and the headset 120 may allow a user to simplify the overall charging experience.

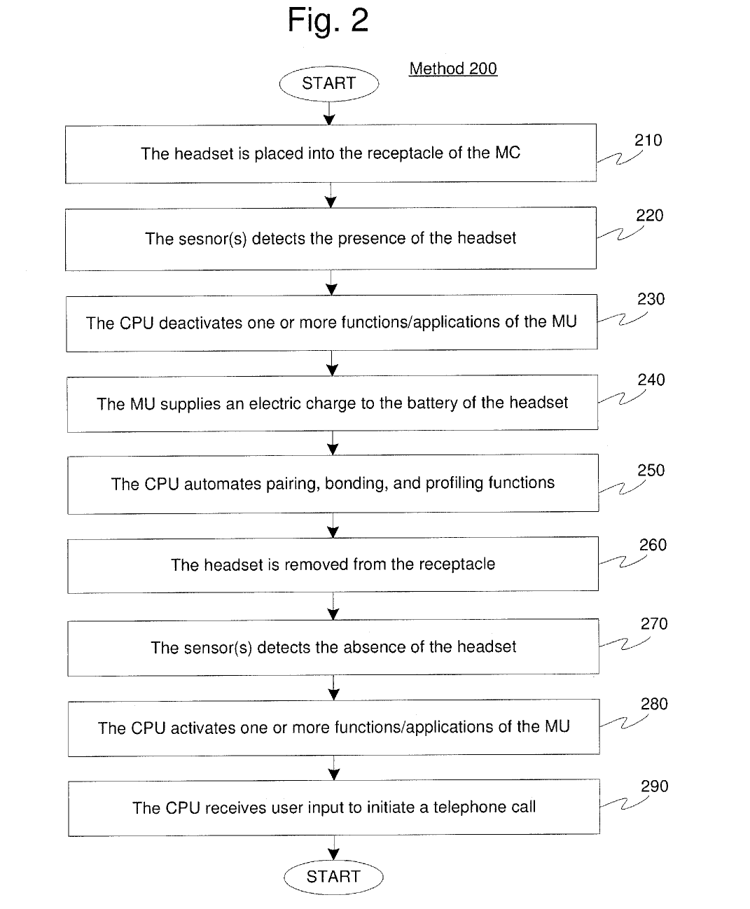

FIG. 2 shows a method 200 according to the exemplary embodiments of the present invention. The exemplary method 200 will be described with reference to the exemplary system 100 of FIG. 1. Accordingly, method 200 may allow for optimizing the functionality and operating parameters of the MC 101. As described above, the CPU 111 of the MC 101 may take into account the presence or absence of the headset 120 within the receptacle 121 in order to determine the activation or deactivation of one or more corresponding functions by the MC 101. Thus, the CPU 111 is able to correlate the location of the headset 120 (e.g., stored in the receptacle 121 or detached from the MC 101) with specific functions and modes of operation of the MC 101.

In step 210, the headset 120 may be placed into the receptacle 121 of the MC 101. As described above, the receptacle 121 may be configured to receive and retain the headset 120. On a rudimentary level, the receptacle 121 may simply serve as a secure location to store the headset 120. Accordingly, the receptacle 121 may allow a user to physically attach the headset 120 to the MC 101, thereby preventing the user from misplacing the headset 120 while the headset 120 is not in use. The receptacle 121 may be designed at a convenient location on the MC 101 that allows the MC 101 to be received by a holder (e.g., a car cradle, a belt clip, etc.) while the headset 120 is stored within the receptacle 121.

In step 220, the CPU 111 may detect the presence of the headset 120 within the receptacle 121 of the MC 101. As discussed above, the receptacle 121 may include the sensor 125, wherein the sensor 125 may be in communication with the CPU 111. An exemplary sensor 125 according to the present invention may be a mechanical switch that is displaced (e.g., retracted into the receptacle 121 or otherwise moved) when the headset 120 is placed into the receptacle 121. Accordingly, the mechanical switch may be replaced (e.g., protracted into the receptacle 121) once the headset 120 has been removed from the receptacle 121. An alternate exemplary sensor 125 according to the present invention may be an electrical detector. As described above, the electrical detector may rely on a measurement of electrical current, resistance, conductivity, etc., for determining the presence and absence of the headset 120 within the receptacle 121. Furthermore, the headset 120 may also include a similar electrical detector (e.g., a reciprocal sensor) that communicates with the sensor 125 to indicate the presence of the headset 120 within the receptacle 121.

In step 230, the CPU 111 may deactivate one or more functions or modes of operation for the MC 101, such as, deactivating a telecommunication application and/or interface (e.g., hanging up on a call), deactivating the display screen, etc. These functions or modes of operation may further include, but are not limited to, a call initiation/termination mode for activating and deactivating the telecommunication features of the MC 101. As described above, in alternative or additional embodiments of the present invention, the CPU 111 may activate a speakerphone mode when the headset 120 is detected in within the receptacle 121.

In step 240, the MC 101 may supply an electronic charge to the headset battery 127. As described above, the charge supplied to the headset 120 may be transmitted by an electronic connection between the headset 120 and the receptacle 121. As described above, when the headset 120 is within the receptacle 121, a power charge may be supplied to the headset battery 127 within the headset 120. This power charge may be supplied either while the MC 101 is connected to an external power source (e.g., an AC adaptor, a charging cradle, a car adaptor, etc.), or while the MC 101 is detached from an external power source. Specifically, the headset battery 127 could be receive either a full charge current from the MC 101 while the MC 101 is connected to an external power source (e.g., when the MC 101 is placed in a charging cradle), or a trickle charge from the battery 185 of the MC 101 while the MC 101 is disconnected from an external power source. Therefore, the supplying of the electric charge to the headset battery 127 may eliminate the need for connecting an additional power source to the headset 120. A user may simply connect the headset 120 to the receptacle 121 in order to charge the headset battery 127.

In step 250, the CPU 111 may automate any bonding, pairing, and profiling functions in order to associate the headset 120 with the MC 101. These functions or modes of operation may include, but are not limited to a battery-charging mode for charging the headset battery 127 via a charge from the receptacle 121 of the MC 101, a call initiation/termination mode for activating and deactivating the telecommunication features of the MC 101, a pairing mode for automatically associating (e.g., pairing, bonding, profiling, etc.) the headset 120 with the MC 101 to allow for wireless communication (e.g., via a Bluetooth standard) between the components. It should be noted that the pairing between the headset 120 and the MC 101 may be performed without any user input. In other words, the process may be transparent to the user of the MC 101.

During the pairing mode, the headset 120 may provide data to the MC 101 in order to set up a connection between the two devices, such as Bluetooth connection. Specifically, in response to a command from the MC 101, the headset 120 may transmit information. This information may include a device name, a device class, a list of services, technical information such as, device features, manufacturer, Bluetooth specification, clock offset, etc. Furthermore, the MC 101 may transmit similar data back to the headset 120. Both the MC 101 and the headset 120 may transmit a device profile. The device profile (e.g., a Bluetooth profile) may be a standardized interface between communication devices such as the MC 101 and the headset 120. For example, the communication device may need to be compatible with certain device profiles in order to use a particular communication standard. Certain communication standards, such as Bluetooth technology, may define a wide range of profiles that describe many different applications. Thus, by following a guidance provided in Bluetooth specifications, developers can create applications to work with other devices also conforming to the Bluetooth specification.

In addition, the headset 120 may establish a trusted relationship with the MC 101 by learning a shared security code, such as a passkey. Accordingly, the MC 101 that wants to communicate only with the headset 120 can authenticate an identity of the device. The MC 101 may further encrypt the data that is exchanged over the air in order to prevent any other devices from listening. The security code may be stored within a memory of the MC 101. Thus, a pairing between the MC 101 and the headset 120 may be preserved, even if the device name has been changed. In addition, a pairing may be deleted at any time by either device.

In step 260, the headset 120 may be removed from the receptacle 121 of the MC 101. The removal of the headset 120 may indicate that a user of the MC 101 intends to place an outbound call or to answer an inbound call. In either event, the removal of the headset 120 from the receptacle 121 may correspond to a user's intent to activate a specific operating mode and/or application of the MC 101.

In step 270, the CPU 111 of the MC 101 may detect the absence of the headset 120 from the receptacle 121 of the MC 101. Specifically, the removal of the headset 120 may detach the headset 120 from the receptacle 121, thereby indicating to the sensor 125 that the headset 120 is no longer present in the receptacle 121. As described above, the sensor 125 may utilize a variety of methods (e.g., magnetic detections, optical detections, mass detections, electrical capacitance, etc.) for determining the presence and absence of the headset 120 within the receptacle 121.

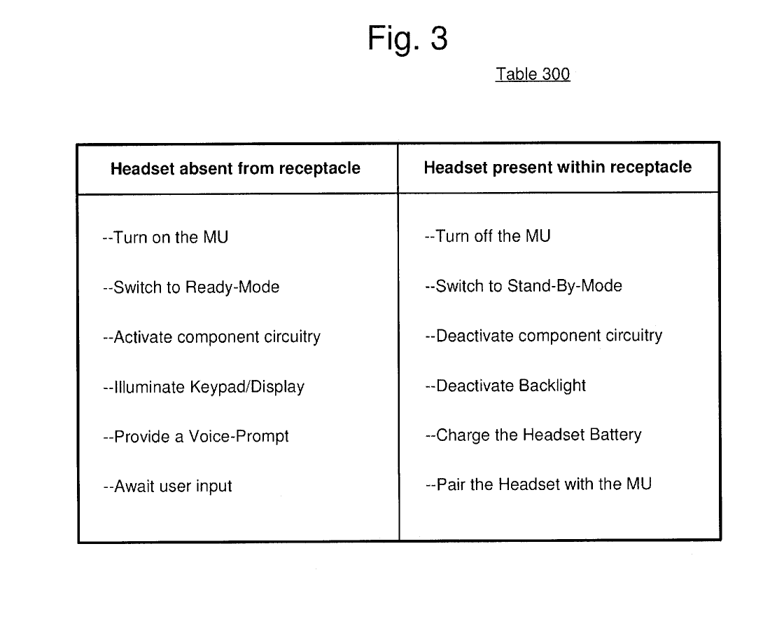

In step 280, the CPU 111 may activate one or more functions or modes of operation for the MC 101, such as, activating a telecommunication application and/or interface, activating the display screen, etc. Specifically, the functions may allow certain components of the MC 101 and the headset 120 to be activated when the components are in use, thereby preserving the power usage of either device (e.g., prolonging the battery life). These functions will be described in greater detail below in FIG. 3.

In step 290, the CPU 111 may receive user input related to the activated function or operation, such as, input from a touch screen or keypad and/or a voice command. Accordingly, the CPU 111 may then activate the various components needed to perform the relevant function (e.g., place a telephone call based on the received user input). Thus, the removal of the headset 120 from the receptacle 121 may effectively eliminate the need for the user to manually activate the telecommunication applications on the MC 101.

FIG. 3 shows a table 300 listing exemplary functions performed by the CPU 111 based on the detected presence or the detected absence of the headset 120 within the receptacle 121 according to the exemplary embodiments of the present invention. Accordingly, the table 300 includes a list of functions the MC 101 may perform when the headset 120 is detected within the receptacle 121 as well as a list of functions the MC 101 may perform when the headset 120 is not detected, or absent. It should be noted that this figure is merely an exemplary list of the functions performed by the MC 101. Depending on a particular use of the MC 101, the functions may be placed on either side of the list or on both sides of the list and any number of additional functions may be placed on the list.

As illustrated in the table 300, the first column may define the various application and/or functions performed by the CPU 111 while the headset 120 is detected to be absent from the receptacle 121. Specifically, these functions may include, but are not limited to: turning on the MU 101; switching a stand-by mode (e.g., a power-conservation mode, or “sleep mode”) of the MU 101 to a ready mode; activating the circuitry for the various components of the MU 101 (the antennae 151, the keypad 171, display 161, etc.); illuminating the keypad 171 and display 161 (e.g., via a backlight); providing a voice-prompt to the user via the speaker 131; awaiting user input (e.g., voice command via microphone 141, tactile input from keypad 171, etc.).

Likewise, the second column may define the various applications and/or functions performed by the CPU 111 while the headset 120 is detected to be present within the receptacle 121. Specifically, these functions may include, but are not limited to: turning off the MU 101; switching a ready mode of the MU 101 to a stand-by mode; deactivating the circuitry for the various components of the MU 101 (the antennae 151, the keypad 171, display 161, etc.); deactivating the backlight illuminating the keypad 171 and display 161; providing a power charge to the battery within the headset 120; pairing the headset 120 with MU 101 in order to establish a communication link. Alternative variations may be applied based on a setting of the MU 101. For example, the MU 101 may be placed in a car-mode, wherein the detection of the headset 120 within the receptacle 121 may activate a speakerphone application of the MU 101.

Furthermore, it should be noted that any number of functions and applications may be performed in response to the absence or presence of the headset 120 in the receptacle 121. The additional functions may be configured into the CPU 111 at the time of manufacture for the MU 101. Additionally, the user of the MU 101 may be allowed to program the CPU 111 in order to customize these functions and applications that are performed.

In one alternative embodiment of the present invention, the MC 101 may selectively activate mobile communications capabilities based on the absence or presence of the headset 120 within the receptacle 121. Specifically, the MC 101 may be usable as a mobile phone having full-duplex and/or half-duplex modes. In the full-duplex mode, the MC 101 may be used as a conventional mobile phone and being held close to the user (as a telephone handset) so that the user can talk and listen simultaneously. According to this exemplary embodiment, a user removing the headset 120 from the receptacle 121 may correlate to the use of the MC 101 in full-duplex mode. In contrast, the MC 101 may also be used in the half-duplex mode as a “walkie-talkie” (i.e., a push-to-talk (“PTT”) mode). According to this exemplary embodiment, a user placing the headset 120 into the receptacle 121 may correlate to the use of the MC 101 in half-duplex mode. Thus, while the headset 120 with present in the receptacle 121, the MC 101 may enable a speaker-phone functionality and the PTT mode in order for the user to hear signals from the speaker even at the distance from the MC 101. Furthermore, the use of the speaker-phone functionality may also include increasing sensitivity of a microphone and/or using signal processing techniques for the user's speech, as is conventionally known.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A mobile computing device, comprising:
a receptacle storing a wireless receiver;
at least one sensor detecting an absence and a presence of the wireless receiver within the receptacle; and
a processor performing at least one action based on one of the detected presence and the detected absence of the wireless receiver from the receptacle.

2. The mobile computing device according to claim 1, wherein the at least one action performed is one of terminating a telephone call on the communication device when the wireless receiver is present in the receptacle and activating a telephone application on the communication device when the wireless receiver is absent in the receptacle.

3. The mobile computing device according to claim 1, wherein the at least one action performed is providing an electronic charge from the communication device to the power supply of the wireless receiver when the wireless receiver is present in the receptacle.

4. The mobile computing device according to claim 3, wherein the electronic charge is one of a trickle charge and a charge current when the mobile computing device is connected to a charging cradle.

5. The mobile computing device according to claim 1, wherein the at least one action performed is one of pairing, bonding, and profiling the wireless receiver with the communication device when the wireless receiver is present in the receptacle.

6. The mobile computing device according to claim 1, wherein the at least one action performed is one of deactivating a component on the communication device when the wireless receiver is present in the receptacle, and activating the component on the communication device when the wireless receiver is absent in the receptacle.

7. The mobile computing device according to claim 6, wherein the component of the communication device is one of a display, a touch screen, a speaker, a microphone, an antenna, a wireless communication interface, an illumination source, and a keypad.

8. The mobile computing device according to claim 1, wherein the wireless receiver is one of a “hands-free” headset and a “hands-free” earpiece.

9. The mobile computing device according to claim 1, wherein the communication device is one of mobile telephone, a Voice over Internet Protocol (“VoIP”) telephone, and a walkie-talkie.

10. The mobile computing device according to claim 1, wherein the interface for wireless communication between the wireless receiver and the communication device is of a Bluetooth standard.

11. The mobile computing device according to claim 1, wherein the at least one sensor is one of a mechanical switch, an electrical detector, a magnetic detector, an optical detector, a mass detector, a capacitance detector, and a conductivity detector.

12. A method, comprising:
detecting one of a presence and an absence of a wireless receiver from a receptacle within a communication device, the wireless receiver including a power supply and an interface for wireless communication with the communication device; and
performing at least one action based on one of the detected presence and the detected absence of the wireless receiver from the receptacle.

13. The method according to claim 12, wherein the at least one action performed is one of terminating a telephone call on the communication device when the wireless receiver is present in the receptacle and activating a telephone application on the communication device when the wireless receiver is absent in the receptacle.

14. The method according to claim 12, wherein the at least one action performed is providing an electronic charge from the communication device to the power supply of the wireless receiver when the wireless receiver is present in the receptacle.

15. The method according to claim 12, wherein the at least one action performed is one of pairing, bonding, and profiling the wireless receiver with the communication device when the wireless receiver is present in the receptacle.

16. The method according to claim 12, wherein the at least one action performed is at least one of deactivating a component on the communication device when the wireless receiver is present in the receptacle, and activating the component on the communication device when the wireless receiver is absent in the receptacle.

17. The method according to claim 16, wherein the component of the communication device is one of a display, a touch screen, a speaker, a microphone, an antenna, a wireless communication interface, an illumination source, and a keypad.

18. The method according to claim 12, wherein the interface for wireless communication between the wireless receiver and the communication device is of a Bluetooth standard.

19. A mobile communication system, comprising:
a sensing means for detecting one of a presence and an absence of a wireless receiver from a receptacle within a communication device, the wireless receiver including a power supply and an interface for wireless communication with the communication device; and
a processing means for performing at least one action based on one of the detected presence and the detected absence of the wireless receiver from the receptacle.

20. The system according to claim 19, wherein the at least one action performed is one of terminating a telephone call on the communication device when the wireless receiver is present in the receptacle and activating a telephone application on the communication device when the wireless receiver is absent in the receptacle.
